(19) United States
(12) Patent Application Publication
(10) Pub. No.: US 2025/0035588 A1
(43) Pub. Date: Jan. 30, 2025

(54) METHOD FOR OPERATING AN ULTRASONIC MEASURING DEVICE, AND AN ULTRASONIC MEASURING DEVICE

(71) Applicant: Endress+Hauser Flowtec AG, Reinach (CH)

(72) Inventors: Jens Rautenberg, Geseke (DE); Achim Stark, Dörfles/Esbach (DE); Stefan Rüger, Jena (DE); Klaus Beringer, Untersiemau (DE); Rudolf Braun, Ahorn (DE); Oliver Berberig, Grenzach-Wyhlen (DE); Michael Münch, Bamberg (DE)

(21) Appl. No.: 18/720,102

(22) PCT Filed: Nov. 21, 2022
(86) PCT No.: PCT/EP2022/082640

§ 371 Date: Jun. 14, 2024

(30) Foreign Application Priority Data
Dec. 15, 2021 (DE) 10 2021 133 188.9

(51) Int. Cl. G01N 29/02

(52) U.S. Cl. CPC G01N 29/02; G01N 2291/0427; G01N 2291/105

(57) ABSTRACT

A method for operating an ultrasonic measuring device for measuring a property of a medium includes: an arrangement of at least two pair of ultrasonic transducers for emitting and receiving ultrasonic signals across a signal path through a fluid; a holding apparatus having a wall in contact with the medium and a flat wall section for holding the ultrasonic transducers; an electronic circuit configured to operate the ultrasonic transducers and to provide measured values of the property, wherein the ultrasonic transducers form Lamb oscillations in the respectively associated wall, wherein at least two pair of the at least two pair of ultrasonic transducers each excite and capture different modes of Lamb oscillations, wherein the different modes are excited in groups, wherein a time delay between temporally adjacent emissions of ultrasonic signals is shorter than a shortest propagation time of the ultrasonic signals between associated ultrasonic transducers.

The application relates to a method for operating an ultrasonic measuring device for detecting a measured variable of a fluid, such as a flow rate or a damping property. The application also relates to an ultrasonic measuring device for implementing the method.

Ultrasonic measuring devices such as those in DE102018133066A1 are state of the art. Accurate determination of measured variables may require precise knowledge of media properties. However, media properties can change dynamically over time, e.g., in processes, so that it May be necessary to check state-of-the-art measuring devices from time to time or at regular intervals.

Therefore, the object of the invention is to propose a method for operating an ultrasonic measuring device and such an ultrasonic measuring device in which a media property can be checked.

The object is achieved by a method according to independent claim 1 and by an ultrasonic measuring device according to independent claim 9.

In a method according to the invention for operating an ultrasonic measuring device for measuring at least one property of a medium, the ultrasonic measuring device comprises:
an arrangement of at least two pairs of ultrasonic transducers for emitting and receiving ultrasonic signals in each case along an associated signal path through a fluid;
a holding apparatus having a wall that is in contact with the media and has a flat wall section or several flat wall sections for holding the ultrasonic transducers, on which the ultrasonic transducers are arranged, wherein sections of the signal paths run through the wall;
an electronic measuring/operating circuit for operating the ultrasonic transducer and for providing measured values of the property,
wherein the ultrasonic transducers form time-limited Lamb oscillations in the respectively associated wall,
at least two pairs of the at least two pairs of ultrasonic transducers each selectively excite and capture one mode of Lamb oscillations, wherein the selectively excited modes of the at least two pairs are each different,
wherein the different modes are excited in groups in a first method step, wherein a time delay between temporally adjacent emissions of ultrasonic signals is shorter than a shortest propagation time of the ultrasonic signals between associated ultrasonic transducers.

In this way, ultrasonic signals of different modes can run simultaneously along their signal paths in sections without causing a disturbing interaction for receiving ultrasonic transducers.

Time-limited means that the ultrasonic signals follow a pulse shape or a burst shape as an ultrasonic signal curve. For example, an ultrasonic signal curve can be described or approximated by a continuous oscillation convolved with a time-limited function such as a rectangular or Gaussian function.

When Lamb waves are generated in a wall, ultrasonic signals are not only emitted into the medium, but also run partially within the wall. Depending upon the arrangement and measurement setup, both parts may be used for a measurement, if necessary.

In one embodiment, the reception of the ultrasonic signals of different modes has a time delay greater than an average duration of the ultrasonic signals.

For this purpose, excitation of the ultrasonic signals of different modes takes place such that the reception of the ultrasonic signals of different modes has a time delay greater than an average duration of the ultrasonic signals.

In one embodiment, the pairs of ultrasonic transducers are each arranged on different groups of flat wall sections with one or two wall sections.

In one embodiment, neighboring flat wall sections are at an angle to each other.

By arranging pairs of ultrasonic transducers on different wall sections, with neighboring wall sections each being at an angle to each other, it is possible to achieve a better temporal separation of different modes of Lamb oscillations.

In one embodiment, at least two of the at least two signal paths have signal propagation times of different length.

In one embodiment, the wall has several wall sections which, in a cross-section through the wall, define an even-numbered polygon such as a rectangle or a cross.

In one embodiment, the electronic measuring/operating circuit detects intensities of ultrasonic signals of the different modes in a second method step and determines at least one physical property of the fluid from the measured intensities in a third method step.

In one embodiment, a Reynolds number is determined in a fourth method step and is used to calculate a property of the medium.

An ultrasonic measuring device according to the invention configured to implement the method according to any one of the preceding claims comprises:
an arrangement of ultrasonic transducers for emitting and receiving ultrasonic signals along at least two signal paths through a fluid,
wherein the arrangement is held by a holding apparatus having at least one wall,
wherein sections of the signal paths run through at least one of the at least one wall, characterized in that
at least two pairs of the at least two pairs of ultrasonic transducers are configured to each excite and capture different modes of Lamb oscillations,
wherein an electronic measuring/operating circuit of the ultrasonic measuring device is configured to excite the different modes in groups in a first method step, wherein a time delay between temporally adjacent emissions of ultrasonic signals is shorter than a shortest propagation time of the ultrasonic signals between associated ultrasonic transducers.

In one embodiment, the holding apparatus is a measuring tube, which measuring tube guides a fluid flowing through a tube line, wherein the ultrasonic transducers are arranged on an outer surface of the measuring tube, or wherein the arrangement with the holding apparatus is immersed in a fluid located, for example, in a container.

The invention will now be shown with reference to exemplary embodiments.

FIG. 1 outlines the structure of an exemplary ultrasonic measuring device with a measuring tube;

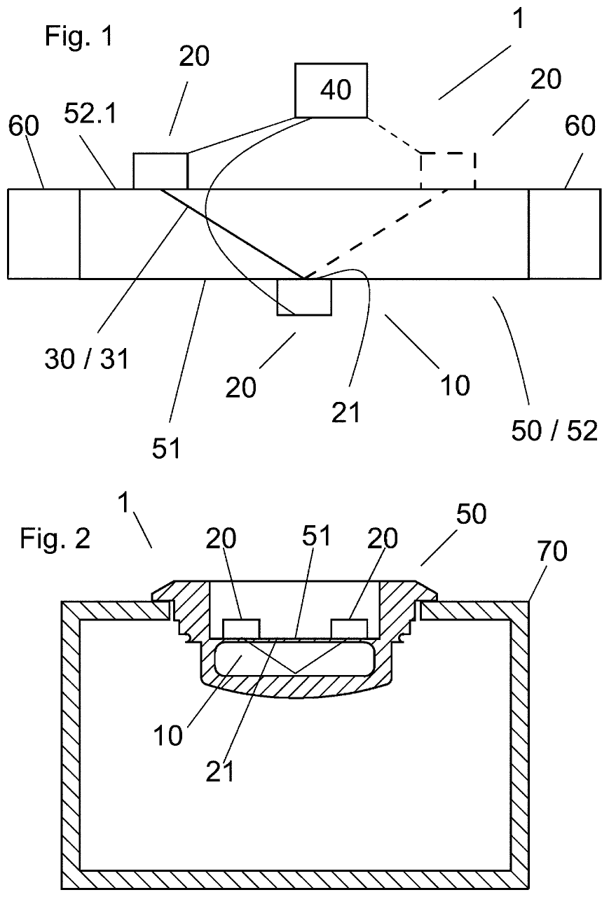

FIG. 2 outlines an exemplary submersible ultrasonic measuring device;

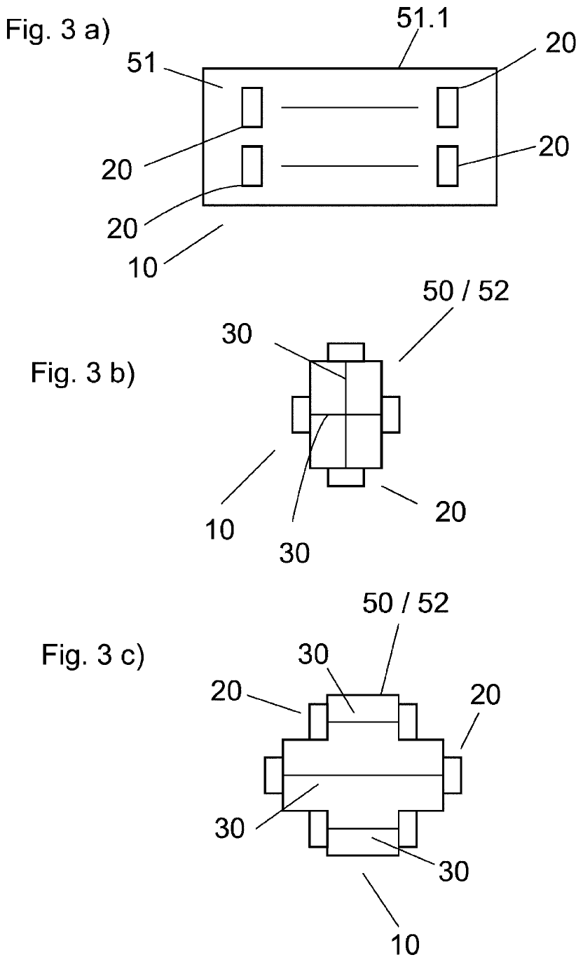

FIG. 3a) shows an exemplary arrangement according to the invention of ultrasonic transducers on a holding apparatus in a top view, and FIGS. 3b) and c) show exemplary arrangements according to the invention of ultrasonic transducers on a holding apparatus, in each case in a front view;

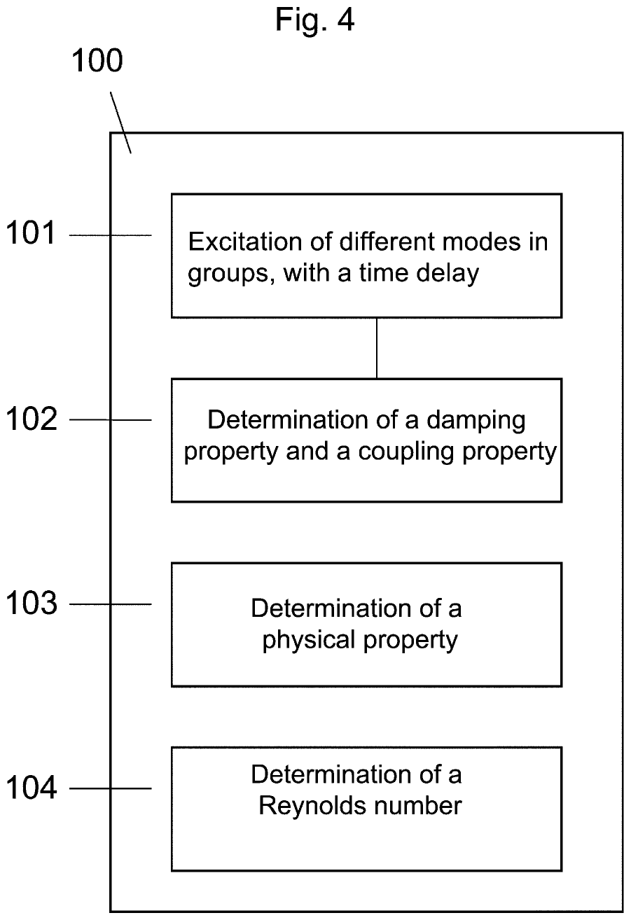

FIG. 4 outlines the sequence of an exemplary method according to the invention.

FIG. 1 outlines the structure of an exemplary ultrasonic measuring device 1 with an arrangement of ultrasonic transducers 20, which are arranged on an outer surface 52.1 of a measuring tube 52 integrated into a tube line 60. The measuring tube acts as a holding apparatus 50 for the ultrasonic transducers 20. A signal path 30 between two ultrasonic transducers 20 can be a single-traverse path without reflection or, as shown in dashed lines, a multi-traverse path with at least one reflection. Signal paths in the fluid in each case have a signal path section 31 with one length in each case.

The ultrasonic transducers of an arrangement are operated by an electronic measuring/operating circuit 40, which is also configured to detect measurement signals from the ultrasonic transducers and provide measured values of a measured variable.

The ultrasonic transducers are Lamb wave ultrasonic transducers. The ultrasonic measuring device has a Lamb wave apparatus 21, which is configured to generate or form and guide Lamb waves. The Lamb wave apparatus can be provided by a wall 51 of the measuring tube. The ultrasonic measuring device can, for example, be a transit time or transit time difference flow meter. The ultrasonic measuring device can also be configured to determine the damping of a fluid.

FIG. 2 outlines an exemplary ultrasonic measuring device 1, which is immersed in a fluid of a container 70. According to the design shown in FIG. 1, the ultrasonic measuring device has an arrangement 10 of ultrasonic transducers 20, which are arranged on a holding apparatus 50 with a wall 51. As shown in FIG. 1, a signal path 30 between two ultrasonic transducers 20 can be a single-traverse path without reflection or a multi-traverse path with at least one reflection. Signal paths have a signal path section 31 with one length in the fluid. The ultrasonic transducers of an arrangement are operated by an electronic measuring/operating circuit 40 (not shown here for the sake of clarity), which is also configured to detect measurement signals from the ultrasonic transducers and provide measured values of a measured variable. The ultrasonic transducers are Lamb wave ultrasonic transducers; the ultrasonic measuring device has a Lamb wave apparatus 21, which is configured to generate Lamb waves or to form and guide Lamb waves. As shown herein, the arrangement/ultrasonic measuring device can be inserted in an opening of a container. An arrangement/ultrasonic measuring device according to the invention can also be used with free-standing fluids.

FIG. 3a) shows an exemplary arrangement according to the invention of ultrasonic transducers on a holding apparatus in a top view, and FIGS. 3b) and c) show exemplary arrangements according to the invention of ultrasonic transducers on a holding apparatus, each in a front view, with which arrangements the method according to the invention can be implemented. According to the invention, at least two pairs of ultrasonic transducers are provided which are configured to excite Lamb waves in the wall 51 of the holding apparatus, wherein at least two of the at least two pairs of ultrasonic transducers are each configured to excite different modes.

As shown in a schematic top view of FIG. 3a), the pairs of ultrasonic transducers can be arranged on a common flat wall section 51.1 of a wall 51, wherein the pairs can be arranged next to each other as shown here by way of example. Alternatively, the pairs can also be arranged one behind 11 the other or so as to be nested within each other, for example. In this way, compact ultrasonic measuring devices can be configured.

As can be seen in FIG. 3b), the holding apparatus 50/measuring tube 52 can, for example, have a rectangular shape, so that two ultrasonic transducers belonging together are at different distances from one another. As shown in FIG. 3c), other cross-sectional shapes can also be used, such as a cross shown as an example. More than two signal paths can also be configured, wherein, as shown here, multiple signal paths in the fluid can have signal path sections of the same length, for example. Cross-sections of the holding apparatuses can generally follow an even-numbered polygonal shape. By arranging pairs of ultrasonic transducers 20 on different 21 wall sections 51, with neighboring wall sections each being at an angle to each other, it is possible to achieve a better temporal separation of different modes of Lamb oscillations.

FIG. 4 outlines the sequence of an exemplary method 100 according to the invention,
wherein, in a first method step 101, different, selectively excited modes are selectively excited in groups by different pairs of ultrasonic transducers, wherein a time delay between temporally adjacent emissions of time-limited ultrasonic signals is shorter than a shortest propagation time of the ultrasonic signals between associated ultrasonic transducers.

In this way, ultrasonic signals of different modes can run simultaneously along their signal paths in sections without causing a disturbing interaction for receiving ultrasonic transducers. For this purpose, in particular, excitation of the ultrasonic signals of different modes can take place such that the reception of the ultrasonic signals of different modes has a time delay greater than an average duration of the ultrasonic signals.

Time-limited means that the ultrasonic signals follow a pulse shape or a burst shape as an ultrasonic signal curve. For example, an ultrasonic signal curve can be described or approximated by a continuous oscillation convolved with a time-limited function such as a rectangular or Gaussian function.

When Lamb waves are generated in a wall, ultrasonic signals are not only emitted into the medium, but also run partially within the wall. Depending upon the arrangement and measurement setup, both parts may be used for a measurement, if necessary.

In one embodiment, in a second method step 102, the electronic measuring/operating circuit 40 of the ultrasonic measuring device can compare intensities of ultrasonic signals along signal paths having signal path sections of different length in the fluid and, in a third method step 103, determine therefrom a damping property of the fluid and/or an acoustic coupling property between the wall and the fluid.

In one embodiment, a Reynolds number is determined in a fourth method step and is used to calculate a property of the medium.

In one embodiment, the signal paths pass through the fluid with a maximum of two reflections, and in particular a maximum of one reflection.

In this way, an interfering interaction of ultrasonic signals and ultrasound in the wall can be avoided.

In general, the invention is not limited to the exemplary embodiments shown here; rather, a person skilled in the art can adapt the inventive concept to his requirements.

### LIST OF REFERENCE SIGNS

1 Ultrasonic measuring device
10 Arrangement of ultrasonic transducers
20 Ultrasonic transducer
21 Lamb wave apparatus
30 Signal path
31 Signal path section in the fluid
40 Electronic measuring/operating circuit
50 Holding apparatus
51 Wall
51.1 Flat wall section
52 Measuring tube
52.1 Outer surface
53 Lamb wave plate
60 Tube line
70 Container
100 Method
101 First method step
102 Second method step
103 Third method step
104 Fourth method step

1-11. (canceled)

12. A method for operating an ultrasonic measuring device for measuring at least one property of a medium, the method comprising:
providing an ultrasonic measuring device, comprising:
an arrangement of at least two pair of ultrasonic transducers configured to emit and receive ultrasonic signals, in each case, along a signal path through a fluid;
a holding apparatus including a wall in contact with the medium, which wall includes a flat wall section or more than one flat wall section adapted for holding the at least two pair of ultrasonic transducers, on which flat wall section the at least two pair of ultrasonic transducers are arranged, wherein sections of each signal path extend through the wall; and
an electronic measuring-operating circuit configured to operate the at least two pair of ultrasonic transducers and to determine measured values of the at least one property,
wherein the at least two pair of ultrasonic transducers generate time-limited Lamb oscillations in the respectively associated wall,
wherein at least two pair of the at least two pair of ultrasonic transducers are each configured to selectively excite and capture one mode of Lamb oscillations,
exciting the different modes are excited in groups, wherein the selectively excited modes of the at least two pair are each different,
wherein a time delay between temporally adjacent emissions of ultrasonic signals is shorter than a shortest propagation time of the ultrasonic signals between associated ultrasonic transducers.

13. The method according to claim 12, further comprising receiving the ultrasonic signals of different modes, which receiving includes a time delay greater than an average duration of the ultrasonic signals.

14. The method according to claim 12, wherein the at least two pair of ultrasonic transducers are each arranged on different groups of flat wall sections with one or two wall sections.

15. The method according to claim 14, wherein adjacent flat wall sections are at an angle to each other.

16. The method according to claim 12, wherein at least two of the at least two signal paths have signal propagation times of different duration.

17. The method according to claim 12, wherein the wall includes several wall sections which, in a cross-section through the wall, define an even-numbered polygon.

18. The method according to claim 17, wherein the even-numbered polygon defines a rectangle or a cross.

19. The method according to claim 12, further comprising, with the electronic measuring-operating circuit:
detecting intensities of ultrasonic signals of the different modes; and
determining at least one physical property of the medium from the measured intensities.

20. The method according to claim 19, further comprising:
determining a Reynolds number; and
calculating at least one further physical of the medium using the determined Reynolds number.

21. An ultrasonic measuring device configured to implement the method according to claim 12, the ultrasonic measuring device comprising:
an arrangement of at least two pair of ultrasonic transducers, each configured to emit and receive ultrasonic signals, in each case, along a signal path through a fluid;
a holding apparatus including a wall in contact with the medium, which wall includes at least one flat wall section adapted for holding the at least two pair of ultrasonic transducers, on which at least one flat wall section the at least two pair of ultrasonic transducers are arranged, wherein sections of each signal path extend through the wall,
wherein at least two pair of the at least two pair of ultrasonic transducers are configured to each excite and capture different modes of Lamb oscillations; and
an electronic measuring-operating circuit configured to:
operate the at least two pair of ultrasonic transducers to generate time-limited Lamb oscillations in the respectively associated wall and to selectively excite and capture the different modes of Lamb oscillations in groups; and
determine measured values of the at least one property,
wherein a time delay between temporally adjacent emissions of ultrasonic signals is shorter than a shortest propagation time of the ultrasonic signals between associated ultrasonic transducers.

22. The ultrasonic measuring device according to claim 21, wherein the holding apparatus is a measuring tube, which measuring tube guides the medium flowing through a tube line,
wherein the ultrasonic transducers are arranged on an outer surface of the measuring tube, or
wherein the arrangement with the holding apparatus is immersed in the medium within a container.

23. The ultrasonic measuring device according to claim 22, wherein the at least two pair of ultrasonic transducers generate ultrasonic Lamb waves in a Lamb wave apparatus provided for this purpose upon the emission of an ultrasonic signal,
wherein the Lamb wave apparatus is the measuring tube wall or a Lamb wave plate of the holding apparatus.
